(19) United States
(12) Patent Application Publication
(10) Pub. No.: US 2010/0218017 A1
(43) Pub. Date: Aug. 26, 2010

(54) NETWORK APPARATUS AND METHOD FOR CONTROLLING NETWORK APPARATUS

(75) Inventor: Keisuke Kitajima, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/707,056

(22) Filed: Feb. 17, 2010

(30) Foreign Application Priority Data
Feb. 26, 2009 (JP) 2009-044630

(51) Int. Cl. G06F 1/32

(52) U.S. Cl. 713/320

(57) ABSTRACT

A CPU of a network apparatus (MFP) counts, based on packets received in a certain period of time, the number of terminal apparatuses from among a plurality of terminal apparatuses that can communicate with the network apparatus. When the counted number of terminal apparatuses is less than the threshold value of the number of available hosts (Th), the network apparatus is controlled to shift into a power-saving state.

### BACKGROUND OF THE INVENTION

1. Field of the Invention

The present invention relates to a network apparatus and a method for controlling the network apparatus.

2. Description of the Related Art

Recently, with rise of environmental consciousness, more apparatuses have been equipped with a power-saving mode in which no power is supplied to parts of an apparatus that do not need any power when the apparatus is not operating. In many cases, even when the apparatus is in the power-saving mode, some parts are still supplied with power that is needed to return the apparatus back to an operational state again at a later time. In other words, power consumption of such an apparatus is not exactly zero.

In other words, the apparatus goes into the above power-saving mode in which less power is consumed so that the apparatus can be used again. Therefore, if a user does not use the apparatus for a long time, environmental load can be reduced by completely stopping the supply of power to the apparatus.

To this end, Japanese Patent Application Laid-Open No. 8-25757 and Japanese Patent Application Laid-Open No. 2002-63006 discuss techniques for transmitting a packet to a network and stopping the supply of power to an apparatus when there is no available host.

For example, in an ordinary office, when company employees (users) are not in the office, e.g., when the users have gone home, office appliances, such as personal computers (PCs) and printing apparatuses, are not used by any user.

Since a PC is basically used only by a particular user, the user himself who uses the PC executes processing for turning off the power of the PC when he leaves the office. However, a network printing apparatus is generally shared by a plurality of users. Therefore, in many cases, even when there is no user in the office, e.g., after company employees (users) have left the office, the apparatus is often left turned on, and the power is wasted.

Further, the conventional technique discussed in Japanese Patent Application Laid-Open No. 8-25757 and Japanese Patent Application Laid-Open No. 2002-63006 have a disadvantage in that an apparatus shared by many users cannot be turned off when there is at least one user. In other words, if there is a user who leaves the office without turning off his PC, the power is wasted. In a printing apparatus used by many users, it is unrealistic to expect that all of the users turn off their PCs.

In a larger office, there are more users, and the office may have a plurality of shared printing apparatuses. In such an environment in which there is a plurality of apparatuses, it is desirable that less apparatuses operate when there are fewer users.

### SUMMARY OF THE INVENTION

The present invention is directed to a network apparatus that can flexibly stop the supply of electricity to the network apparatus, according to an operational state of a terminal apparatus serving as a host and a method for controlling the network apparatus.

According to an aspect of the present invention, a network apparatus is provided that can communicate with a plurality of terminal apparatuses via a network. The network apparatus includes a receiving unit configured to receive packets from the plurality of apparatuses, a counting unit configured to count, based on packet received by the receiving unit in a certain period of time, the number of terminal apparatuses of the plurality of terminal apparatuses that can communicate with the network apparatus, a control unit configured to cause the network apparatus to go into a power-saving state where the number of terminal apparatuses counted by the counting unit is less than a predetermined threshold value, and a threshold setting unit configured to set the predetermined threshold value.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the invention.

FIG. 1 is a block diagram illustrating a multifunction peripheral (MFP) to which a network apparatus can be applied.

FIG. 2 is a plan view illustrating an example of a configuration of an operation unit 40 illustrated in FIG. 1.

FIG. 3 illustrates a configuration of a network system to which the MFP illustrated in FIG. 1 is applied.

FIG. 4 illustrates a host Internet Protocol (IP) list stored in the MFP 1 illustrated in FIG. 3.

FIG. 5 illustrates a change of the host IP list.

FIG. 6 is a flowchart illustrating a host IP counting processing.

FIG. 7 is a flowchart illustrating a main power source control processing.

FIG. 8 illustrates an example of settings of threshold values about the number of available hosts (Th) each of which is set per period of time.

FIG. 9 is a flowchart illustrating a change processing of the threshold value of the number of available hosts.

FIG. 10 is a flowchart illustrating processing during booting.

FIG. 11 illustrates an example of a configuration of a network system according to a second exemplary embodiment.

FIG. 12 illustrates an exemplary screen of a monitored printing apparatus registration screen according to the second exemplary embodiment.

FIG. 13 is a flowchart illustrating an example of a slave confirmation processing.

FIG. 14 is a flowchart illustrating an addition or edition processing of a registered slave list.

FIG. 15 illustrates an exemplary screen of a monitored printing apparatus input screen according to the second exemplary embodiment.

### DESCRIPTION OF THE EMBODIMENTS

Various exemplary embodiments, features, and aspects of the invention will be described in detail below with reference to the drawings.

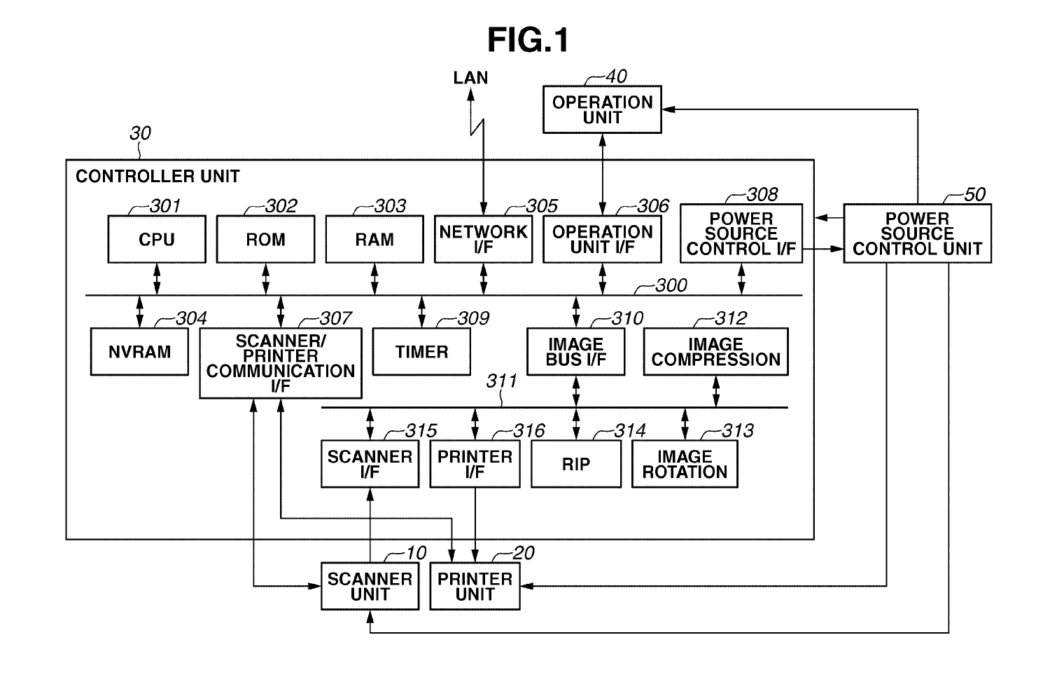

FIG. 1 is a block diagram illustrating an example of a configuration of a multifunction peripheral (MFP), i.e., an example of a printing apparatus to which a network apparatus according to an exemplary embodiment of the present invention can be applied.

In FIG. 1, a scanner unit 10 serves as an image reading unit for generating image data by reading a document placed thereon by a user. The scanner unit 10 uses a document illumination lamp made of, e.g., a halogen lamp, to expose the document placed on a platen glass, uses a charge coupled device (CCD) sensor to receive a light reflected by the document, and outputs an image signal of the received light.

A printer unit 20 forms an electrostatic latent image by exposing a photosensitive member based on image data, develops the formed electrostatic latent image with a developer (toner), and forms an image by transferring the developed electrostatic latent image onto a recording sheet. The printer unit 20 serves as an image forming unit. Incidentally, the scanner unit 10 and the printer unit 20 may be configured in any way as long as they are equipped with generally available configurations and functions of well-known printers and scanners. The detailed description about generally available functions and structures of an image processing apparatus is not described here.

A controller unit 30 is connected to the scanner unit 10 serving as an image reading device, the printer unit 20 serving as an image forming device, an operation unit 40 serving as a user interface, and an external interface (I/F) such as a local area network (LAN). The controller unit 30 is a unit for processing and controlling image information and device information.

In the controller unit 30, a central processing unit (CPU) 301 executes various programs for control processing routines and other processing described below. The read-only memory (ROM) 302 stores a boot program for allowing the CPU 301 to operate and various programs such as the control processing routines described below.

A random access memory (RAM) 303 is used as an image memory serving as a work area and a temporary storage area storing image data when the CPU 301 executes various programs. A nonvolatile random access memory (NVRAM) 304 stores various control parameters.

A network I/F 305 is connected to a LAN, and performs various network controls such as transmission and reception of e-mails and input and output of page description language (PDL) data from a host. Further, the network I/F 305 is connected to an NVRAM (not illustrated), which stores various parameters of the network I/F 305 such as media access control (MAC) addresses.

An operation unit I/F 306 is an I/F for communicating with the operation unit 40, which will be described below. A scanner/printer communication I/F 307 is an I/F for communicating with the above-described CPU 301 of the scanner unit 10 and the printer unit 20.

A power source control I/F 308 instructs a power source control unit 50 to stop various power supplies according to instructions given by the CPU 301. A timer unit 309 stores a current time therein and monitors whether a predetermined period of time has passed. The above-described units are arranged on a system bus 300.

An image bus interface (I/F) 310 is a bridge connecting the system bus 300 and an image bus 311 for transferring an image signal. The image bus 311 is connected to the following blocks. An image compression unit 312 performs compression and decompression processing for Joint Photographic Experts Group (JPEG), Joint Bi-level Image Experts Group (JBIG), Modified Modified Read (MMR), Modified Huffman (MH). An image rotation unit 313 performs rotation processing of image data. A raster image processor (RIP) unit 314 expands PDL codes into a bit map raster image.

A scanner I/F unit 315 performs scanner image processing, such as correction, modulation, and editing, on data input from the scanner unit 10. A printer I/F unit 316 performs printer image processing, such as correction of a printer and resolution conversion, on print output image data, and transfer the print data to the printer unit 20. The description about the controller unit 30 ends here.

The power source control unit 50 uses an alternating current (AC) power source input from a commercial power source to generate various direct current (DC) powers, and supplies powers to the scanner unit 10, the printer unit 20, the controller unit 30, and the operation unit 40, according to instructions given by the power source control I/F 308 of the controller unit 30.

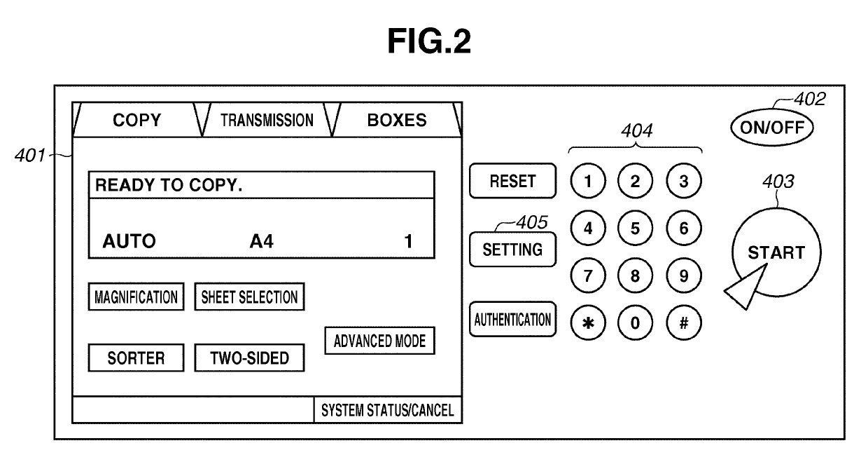

FIG. 2 shows an example of a configuration of the operation unit 40 illustrated in FIG. 1. As illustrated in FIG. 2, the operation unit 40 serves as various key input units for receiving inputs given by a user. The operation unit 40 includes an ON/OFF key 402, a start key 403, a numeric keypad 404, and a setting key 405.

The ON/OFF key 402 is a key with which a user gives an instruction for displaying or hiding the user interface. The start key 403 is a key with which a user gives an instruction for starting copy operation. The numeric keypad 404 is a set of keys for inputting numeric numbers. The setting key 405 is a key for switching the screen to various setting screens.

Further, the operation unit 40 has a touch panel display (hereinafter referred to as touch panel) 401, on which an image is displayed for a user. The touch panel 401 receives inputs given by the user when the user touches the touch panel 401.

Subsequently, about the processing according to the present invention, the overview of processing in an expected environment will be described. Thereafter, the processing in each unit will be described with reference to flowcharts.

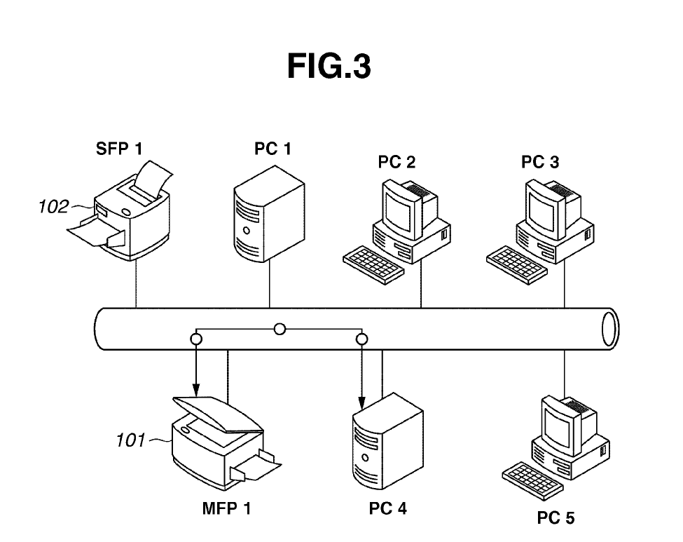

FIG. 3 illustrates an example of a configuration of a network system, to which the MFP illustrated in FIG. 1 is applied as a network apparatus according to the present exemplary embodiment. As illustrated in FIG. 3, the MFP 1 (101) is a printing apparatus, i.e., the network apparatus according to the present invention. The MFP 1 (101) has the configuration illustrated in FIG. 1.

The network system includes a single-function printing apparatus (SFP) 1 (102). The MFP 1 (101) and the SFP 1 (102) are connected to each host PC (terminal apparatuses such as PC 1 to PC 5) via the network I/F 305 to communicate therewith.

Each host PC (e.g., PC 1 to PC 5) can transmit a packet for instructing printing to a printer device in which a printer driver is installed. A PC with a generally available Operating System (OS) installed such as Windows (registered trademark) transmits a packet for confirming a status to a printer device in which a printer driver is installed in the PC.

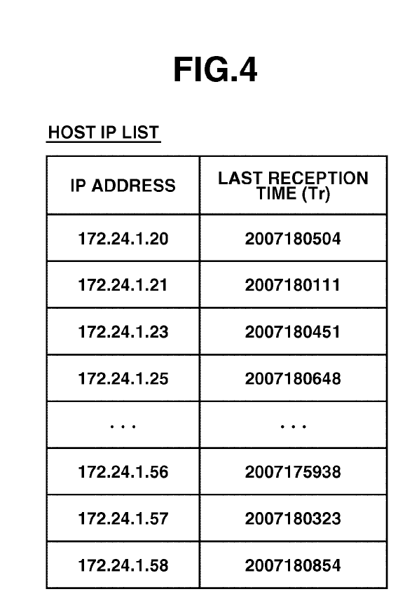

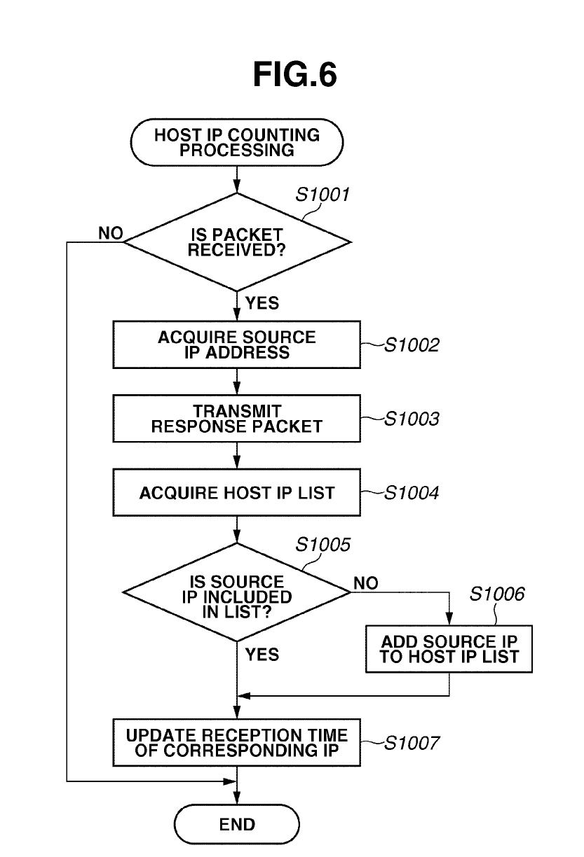

The MFP 1 (101) performs a below-described host Internet Protocol (IP) counting processing illustrated in FIG. 6 to generate a host IP list illustrated in FIG. 4, thus managing host PCs connected to the MFP 1 (101).

FIG. 4 illustrates an example of the host IP list stored in the MFP 1 (101) illustrated in FIG. 3. As illustrated in FIG. 4, the host IP list includes items such as host IP addresses and last reception times (Tr). This host IP list is stored in the RAM 303 or the NVRAM 304 of the MFP 1 (101).

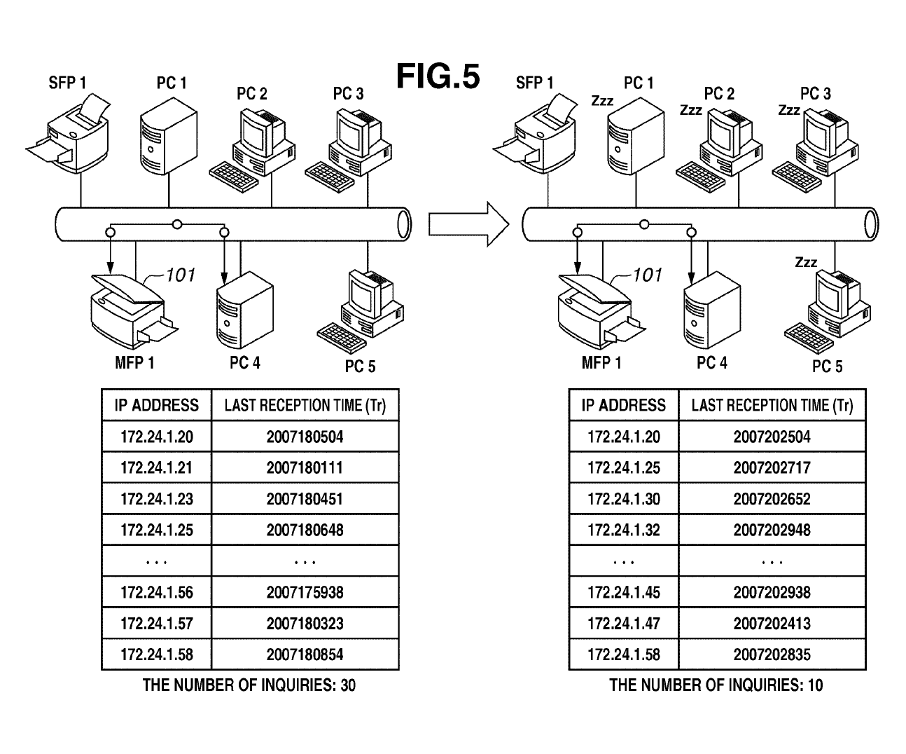

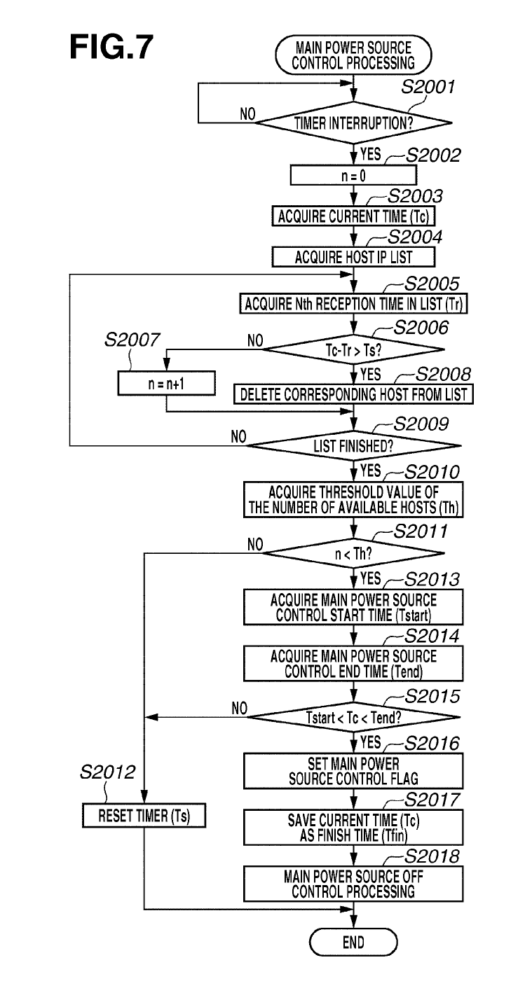

FIG. 5 illustrates a change of the host IP list illustrated in FIG. 4. The MFP 1 (101) executes a below-described main power source control processing, illustrated in FIG. 7 and described below, at a regular interval of time.

In this main power source control processing, when a host PC is turned off (which is indicated by “Zzz” in FIG. 5), the number of available hosts is compared with a predetermined threshold value (threshold value (Th) of the number of available hosts) set in the apparatus in advance. When the number of available hosts is less than the predetermined threshold value, the MFP 1 (101) turns off the main power source of the MFP 1 (101) (main power source OFF control).

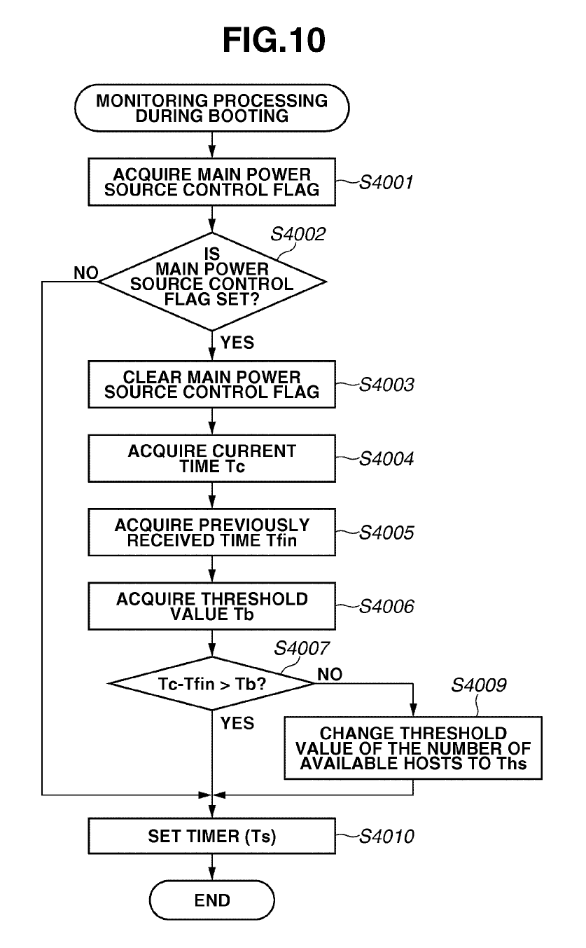

At this moment, the MFP 1 (101) stores, in the NVRAM 304, the time (Tfin) at which the above main power source control processing is performed. This time (Tfin) is used by a below-described monitoring processing during booting illustrated in FIG. 10.

In the monitoring processing during booting, the MFP 1 (101) determines, based on a time difference between the current time and the above time (Tfin) during booting, whether users operating available host PCs use the host PCs. When the MFP 1 (101) determines that some of users are still using the host PCs, the MFP 1 (101) changes the threshold value (Th) of the number of available hosts.

The host IP counting processing according to the present exemplary embodiment will be described below with reference to FIG. 6, which illustrates the host IP counting processing performed in the network apparatus according to the exemplary embodiment of the present invention. Incidentally, the processing in FIG. 6 is achieved by the CPU 301 of the MFP 1 (101) by reading and executing a program stored in the ROM 302.

In step S1001, when a particular packet is determined to be received (Yes in step S1001), the CPU 301 of the MFP 1 (101) executes the processing in step S1002 and subsequent steps.

In this way, it is not necessary to execute processing on all the packets. This function can be achieved by executing the processing in step S1002 and subsequent steps based on a state of reception of the particular packet (when the particular packet is determined to be received). The particular packet is, for example, an Address Resolution Protocol (ARP) packet and a status confirmation packet sent by a host PC to a printer device via a Simple Network Management Protocol (SNMP).

In step S1002, the CPU 301 of the MFP 1 (101) acquires the source IP address of the received packet. In step S1003, the CPU 301 of the MFP 1 (101) sends a response packet to the source IP address.

In step S1004, the CPU 301 of the MFP 1 (101) acquires a host IP list illustrated in FIG. 4 from the memory (RAM 303). Subsequently, in step S1005, the CPU 301 of the MFP 1 (101) determines whether the source IP address acquired in step S1002 is included in the host IP list acquired in step S1004.

Then, when the source IP address is determined not to be included in the host IP list (No in step S1005), the CPU 301 of the MFP 1 (101) adds the source IP address to the host IP list, in step S1006. Then, the processing proceeds to step S1007.

On the other hand, when the source IP address is determined to be included in the host IP list (Yes in step S1005), the processing proceeds to step S1007 without adding the source IP address.

Then, in step S1007, the CPU 301 of the MFP 1 (101) updates a last reception time (Tr) corresponding to the source IP address acquired in step S1002 to the time at which the particular packet was received, and terminates the processing of FIG. 6.

By the above-described processing, the time at which the MFP 1 (101) last received the particular packet and the host IP list for the MFP 1 (101) can be referenced.

The main power source control processing according to the present exemplary embodiment will be described with reference to FIG. 7, which illustrates the main power source control processing performed by the network apparatus according to the present exemplary embodiment. Incidentally, the processing in FIG. 7 is achieved by causing the CPU 301 of the MFP 1 (101) by reading and executing a program stored in the ROM 302.

First, in step S2001, the CPU 301 of the MFP 1 (101) checks an interruption issued from the timer unit 309. Only when an interruption is issued (YES in step S2001), the CPU 301 of the MFP 1 (101) performs the processing in step S2002 and subsequent steps described blow. The timer unit 309 issues the interruption at a regular interval of a host monitoring time (Ts) set in advance.

In step S2002, the CPU 301 of the MFP 1 (101) initializes a variable n (stored in the RAM 303) representing the number of available hosts to “0”, and the processing proceeds to step S2003.

Subsequently, in step S2003, the CPU 301 of the MFP 1 (101) acquires the current time (Tc) from the timer unit 309. In step S2004, the CPU 301 of the MFP 1 (101) acquires the host IP list from the RAM 303.

Subsequently, in step S2005, the CPU 301 of the MFP 1 (101) acquires the nth last reception time (Tr) from the host IP list. Subsequently, in step S2006, the CPU 301 of the MFP 1 (101) compares the host monitoring time (Ts) and a time difference (Tc−Tr) between the current time (Tc) and the last reception time (Tr). The host monitoring time (Ts) is set and stored in the NVRAM 304 in advance.

Then, when the time difference (Tc−Tr) is determined to be more than the host monitoring time (Ts) (Yes in step S2006), the CPU 301 of the MFP 1 (101) deletes the n-th IP list from the host IP list in step S2008. Then, the processing proceeds to step S2009.

On the other hand, in step S2006, when the time difference (Tc−Tr) is determined not to be greater than the host monitoring time (Ts) (No in step S2006), in step S2007, the CPU 301 of the MFP 1 (101) increments the variable n. Then, the processing proceeds to step S2009.

Subsequently, in step S2009, the CPU 301 of the MFP 1 (101) determines whether the processing of steps S2005 to S2008 has been performed on all of the items in the host IP list. When the CPU 301 of the MFP 1 (101) determines that the processing has not yet been performed on all of the items in the host IP list (NO in step S2009), the processing returns back to step S2005.

In step S2009, when the CPU 301 of the MFP 1 (101) determines that the processing in steps S2005 to S2008 has been performed on all of the items, the processing proceeds to step S2010.

Subsequently, in step S2010, the CPU 301 of the MFP 1 (101) acquires a threshold value of the number of available hosts (Th). An administrator previously sets the threshold value of the number of available hosts (Th) by performing threshold value setting operation on the operation unit 40. The threshold value of the number of available hosts (Th) is stored in a storage area designated for a threshold value of the number of available hosts in the NVRAM 304.

Subsequently, in step S2011, the CPU 301 of the MFP 1 (101) compares the threshold value of the number of available hosts (Th) acquired in step S2010 and the number of elements (the number of available hosts) n in the host IP list acquired from the above processing (comparison processing of the threshold value of the number of available hosts).

In step S2011, when the CPU 301 of the MFP 1 (101) determines that the number of elements n in the host IP list is determined to be equal to or more than the threshold value of the number of available hosts (Th) (No in step S2011), the processing proceeds to step S2012.

In step S2012, the CPU 301 of the MFP 1 (101) resets the host monitoring time (Ts) in the timer unit 309, and terminates the processing of this flowchart.

The timer unit 309 issues the interruption executed in step S2001 based on the host monitoring time (Ts) reset in step S2012. Therefore, host IP counting means can count the number of available hosts registered in the host IP list in a certain period of time.

On the other hand, in step S2011, when the CPU 301 of the MFP 1 (101) determines that the number of elements n in the host IP list is less than the threshold value of the number of available hosts (Th) (Yes in step S2011), the processing proceeds to step S2013.

In step S2013, the CPU 301 of the MFP 1 (101) acquires a main power source control start time (Tstart) set in the apparatus. In step S2014, the CPU 301 of the MFP 1 (101) acquires a main power source control end time (Tend). An administrator previously sets the main power source control start time (Tstart) and the main power source control end time (Tend) by performing period setting operation on the operation unit 40. The main power source control start time (Tstart) and the main power source control end time (Tend) are stored in a period storage area in the NVRAM 304.

Subsequently, in step S2015, the CPU 301 of the MFP 1 (101) determines whether the current time (Tc) acquired in step S2003 is between the main power source control start time (Tstart) and the main power source control end time (Tend).

Then, in step S2015, when the CPU 301 of the MFP 1 (101) determines that the current time (Tc) is not between the main power source control start time (Tstart) and the main power source control end time (Tend) (No in step S2005), the processing proceeds to step S2012. Then, in step S2012, the timer is set in the timer unit 309 again, and the processing of FIG. 7 is terminated.

In step S2015, when the CPU 301 of the MFP 1 (101) determines that the current time (Tc) is between the main power source control start time (Tstart) and the main power source control end time (Tend) (Yes in step S2015), the processing proceeds to step S2016.

In step S2016, the CPU 301 of the MFP 1 (101) sets a main power source control flag to the NVRAM 304 (the main power source control flag is turned on and is stored in the NVRAM 304).

Further, in step S2017, the CPU 301 of the MFP 1 (101) stores the current time (Tc) (i.e., the time at which the main power source control processing is performed) as a processing finish time (Tfin) to the NVRAM 304 (finish time storing processing).

Subsequently, in step S2018, the CPU 301 of the MFP 1 (101) notifies (instructs) the power source control unit 50 of the MFP 1 (101) to turn off the main power source (main power source OFF control processing), and terminates the processing of this flowchart.

When the power source control unit 50 receives an instruction for turning off the main power source from the CPU 301 via the power source control I/F 308, the power source control unit 50 shuts off the supply of power to the scanner unit 10, the printer unit 20, the controller unit 30, and the operation unit 40.

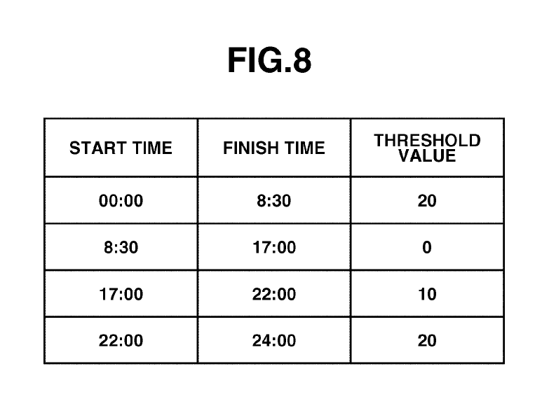

In the processing in the above flowchart, the main power source control period is designated using only the main power source control start time (Tstart) and the main power source control end time (Tend). Alternatively, as illustrated in FIG. 8, the relationship between the power source control and the time may be controlled by dividing twenty four hours into many periods and changing the threshold value of the number of available hosts (Th).

FIG. 8 illustrates an example of settings of the threshold values of the number of available hosts (Th) each of which is set per period of time in the network apparatus according to the exemplary embodiment of the present invention.

In the example illustrated in FIG. 8, the threshold value of the number of available hosts (Th) is set to “20” in a period of time of 00:00 to 08:30. The threshold value of the number of available hosts (Th) is set to “0” in a period of time of 8:30 to 17:00. The threshold value of the number of available hosts (Th) is set to “10” in a period of time of 17:00 to 22:00. The threshold value of the number of available hosts (Th) is set to “20” in a period of time of 22:00 to 24:00. In this way, each of the plurality of threshold values of the number of available hosts (Th) is set in association with any one of the plurality of periods.

As described above, the threshold value of the number of available hosts (Th) is set to a larger value in a period of time in which there may be a few users, and the threshold value of the number of available hosts (Th) is set to a smaller value in a period of time in which there may be many users. Thus, it is possible to precisely control the power source of the operating printing apparatus.

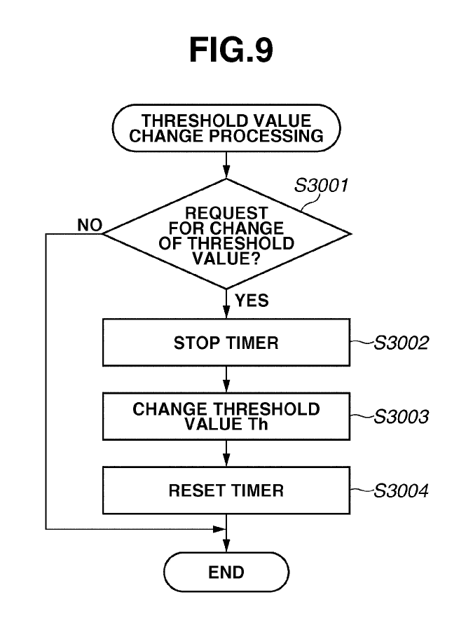

The change processing of the threshold value of the number of available hosts according to the present exemplary embodiment will be described below with reference to FIG. 9.

FIG. 9 illustrates the change processing of the threshold value of the number of available hosts performed by the network apparatus according to the present exemplary embodiment. The processing in this flowchart is achieved by the CPU 301 of the MFP 1 (101) by reading and executing a program stored in the ROM 302.

In step S3001, when the CPU 301 of the MFP 1 (101) determines that there is a change request of the threshold value of the number of available hosts (Th) (Yes in step S3001), the CPU 301 of the MFP 1 (101) executes the processing in step S3002 and subsequent steps.

A user can issue a change request (setting request) of the threshold value of the number of available hosts (Th) by pressing the setting key 405 on the operation unit 40 of MFP (101), which is displayed on the touch panel 401 of the operation unit 40. The setting of the threshold value can be changed on this setting change screen.

When the MFP 1 (101) is configured so that the threshold values are set per period of time as illustrated in FIG. 8, the period of time (start time and end time) and the threshold value associated with the period of time can be changed on this setting change screen. Alternatively, the MFP 1 (101) may be configured so that the threshold values (and the periods of times) are remotely changed by each host PC.

In step S3002, the CPU 301 of the MFP 1 (101) performs a timer stop processing so that an interruption is not issued by the timer unit 309. Subsequently, in step S3003, the CPU 301 of the MFP 1 (101) changes the threshold value of the number of available hosts (Th) to a requested threshold value, and stores the threshold value.

Subsequently, in step S3004, the CPU 301 of the MFP 1 (101) resets the host monitoring time (Ts) to the timer unit 309, and terminates the processing of this flowchart. The timer unit 309 issues the interruption in FIG. 7 described above based on the host monitoring time (Ts) set in step S3004.

When the MFP 1 (101) is turned on, the CPU 301 of the MFP 1 (101) reads programs from the ROM 302, expands the programs to the RAM 303, and performs various kinds of processing needed during booting.

The processing during booting according to the present exemplary embodiment will be hereinafter described with reference to FIG. 10, which illustrates the processing during booting performed by the network apparatus according to the present exemplary embodiment.

Incidentally, the processing in FIG. 10 is achieved by the CPU 301 of the MFP 1 (101) by reading and executing a program stored in the ROM 302. The following processing may be performed at a time period after the initialization of various devices and before the completion of the booting.

First, in step S4001, the CPU 301 of the MFP 1 (101) acquires the main power source control flag from the NVRAM 304. This main power source control flag is stored in the NVRAM 304 in the main power source control processing illustrated in FIG. 7. This main power source control flag represents whether the main power source OFF control processing has been performed in the above-described main power source control processing.

Subsequently, in step S4002, the CPU 301 of the MFP 1 (101) determines whether the main power source control flag acquired in step S4001 has been set (ON). When the main power source control flag is determined not to be set (OFF) (NO in step S4002), the CPU 301 of the MFP 1 (101) terminates the processing of this flowchart.

In step S4002, when the CPU 301 of the MFP 1 (101) determines that the main power source control flag is set (ON) (YES in step S4002), the processing proceeds to step S4003.

In step S4003, the CPU 301 of the MFP 1 (101) clears (turns off) the main power source control flag in the NVRAM 304, and the processing proceeds to step S4004.

Subsequently, in step S4004, the CPU 301 of the MFP 1 (101) acquires the current time (Tc) from the timer unit 309. In step S4005, the CPU 301 of the MFP 1 (101) acquires the processing finish time (Tfin) from the NVRAM 304.

Then, in step S4006, the CPU 301 of the MFP 1 (101) acquires a boot time monitoring threshold value (Tb) representing a threshold value of a time between the main power source control processing and the boot processing, and the processing proceeds to step S4007. An administrator previously sets the boot time monitoring threshold value (Tb) by performing setting operation on the operation unit 40. The boot time monitoring threshold value (Tb) is stored in a storage area designated for the boot time monitoring threshold value in the NVRAM 304.

In step S4007, the CPU 301 of the MFP 1 (101) calculates an elapsed time (Tc−Tfin), i.e., the time between when the main power source off control processing has been executed and the present time, and compares the elapsed time (Tc−Tfin) and the boot time monitoring threshold value (Tb) to determine whether the elapsed time (Tc−Tfin) exceeds the boot time monitoring threshold value (Tb) (the boot time monitoring threshold value comparison processing).

Then, in step S4007, when the CPU 301 of the MFP 1 (101) determines that the elapsed time (Tc−Tfin) does not exceed the boot time monitoring threshold value (Tb) (NO in step S4007), the processing proceeds to step S4009. In this case, the CPU 301 of the MFP 1 (101) can determine that the MFP 1 (101) is booted by a user of a currently available host immediately after the main power source is turned off in the above-described main power source control processing.

In step S4009, the CPU 301 of the MFP 1 (101) changes the threshold value of the number of available hosts (Th) stored in the NVRAM 304 to a smaller threshold value (Ths) than the already set value, and the processing proceeds to step S4010.

On the other hand, in step S4007, when the CPU 301 of the MFP 1 (101) determines that the elapsed time (Tc−Tfin) exceeds the boot time monitoring threshold value (Tb) (YES in step S4007), the processing proceeds to step S4010.

In step S4010, the CPU 301 of the MFP 1 (101) sets the timer unit 309 to the host monitoring time (Ts), and terminates the processing of this flowchart. The timer unit 309 issues the interruption of FIG. 7 described above based on the host monitoring time (Ts) set here in step S4010.

As described above, the main power source of the network apparatus can be turned off even when not all of the hosts using the network apparatus (MFP) are completely turned off. Further, even when there are some users who leave the office without turning off PCs, the network apparatus can be turned off, so that wasteful power consumption can be reduced.

Further, in an environment in which a plurality of network apparatuses operate, the threshold value of the number of available hosts may be set stepwise in each network apparatus. Such configuration enables further reducing power consumption by reducing the number of operating network apparatuses according to the decrease of users using the apparatuses.

In addition, just like the MFP 1 (101), the SFP 1 (102) illustrated in FIG. 3 may be configured to control the power source. More specifically, the nonvolatile memory in the SFP 1 (102) may store the threshold value of the number of available hosts (Th) in advance, and the SFP 1 (102) may be configured to turn off the main power source of the SFP 1 (102) when the number of available hosts becomes less than the threshold value of the number of available hosts (Th).

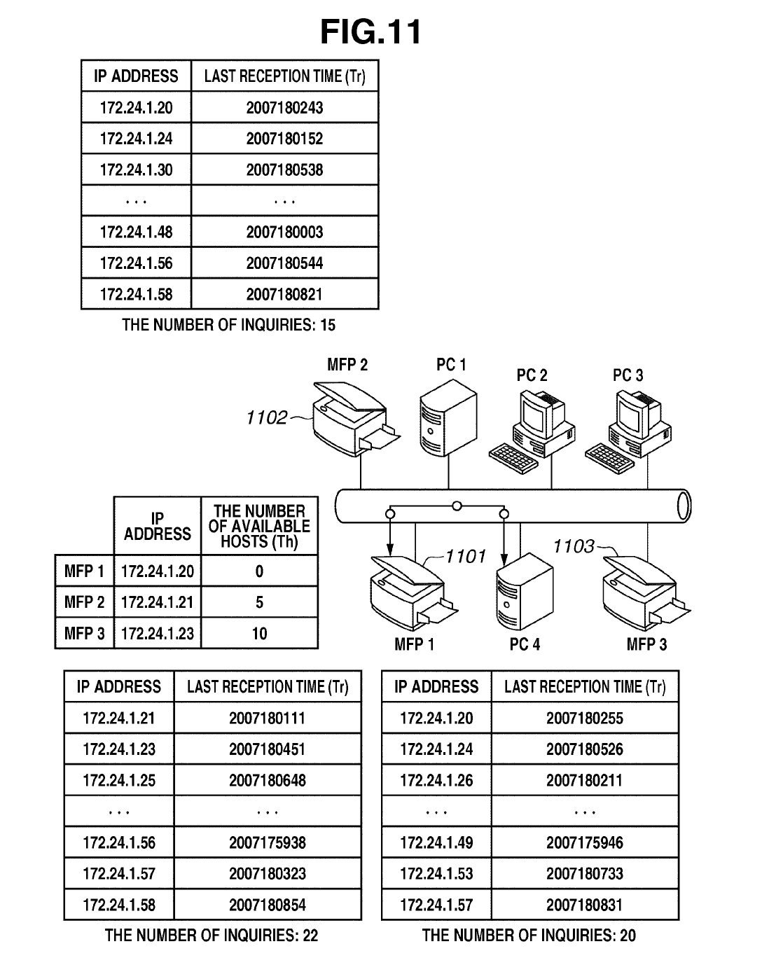

Next, main power source control processing of a plurality of printing apparatuses according to an exemplary embodiment of the present invention will be described below. FIG. 11 illustrates an example of a configuration of a network system to which the network apparatus according to a second exemplary embodiment of the present invention is applied.

As illustrated in FIG. 11, the MFP 1 (1101) to the MFP 3 (1103) are printing apparatuses, i.e., the network apparatuses according to the present exemplary embodiment, and have the configuration illustrated in FIG. 1. The MFP 1 (1101) to the MFP 3 (1103) are connected communicatably to each host PC (terminal apparatuses such as PC 1 to PC 5) via the network I/F 305.

Each host PC (e.g., PC 1 to PC 5) can transmit a packet for instructing printing to a printer device in which a printer driver is installed. A PC, with a generally available Operating System (OS) such as Windows (registered trademark) installed, transmits a packet for confirming a status to a printer device in which a printer driver is installed.

As described in the first exemplary embodiment, each of the MFP 1 (1101) to the MFP 3 (1103) counts the number of IP addresses of hosts, and compares the number of the hosts with the threshold value of the number of available hosts stored in each apparatus. When the number of the hosts is determined to be less than the threshold value, each of the MFP 1 (1101) to the MFP 3 (1103) turns off the main power source. In other words, each of the MFP 1 (1101) to the MFP 3 (1103) has the same function as that of the above-described MFP 1 (101) according to the first exemplary embodiment.

In the present exemplary embodiment, the MFP 1 (1101) serves as a master for other MFPs. The MFP2 (1102) and MFP3 (1103) serve as slaves. In addition, the MFP 1 (1101) can instruct the MFP2 (1102) and MFP3 (1103) to change the threshold value of the number of available hosts. Therefore, one MFP can collectively manage the threshold values of all of the MFPs.

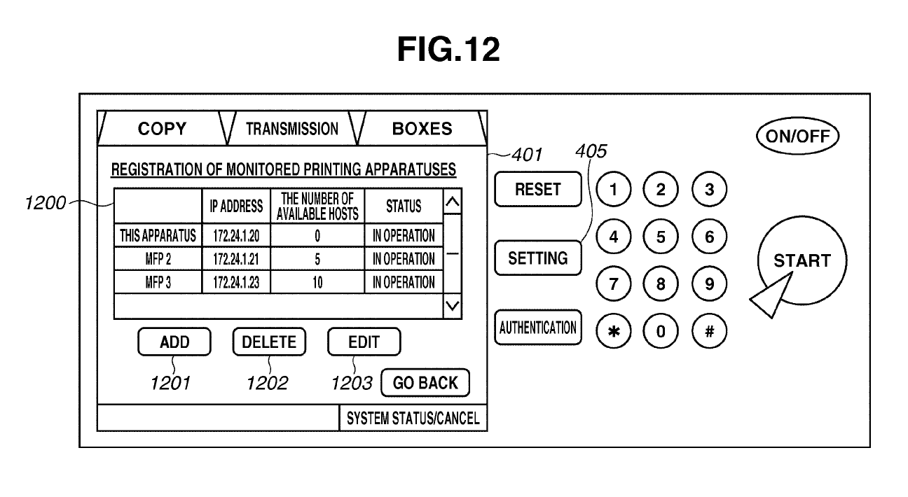

FIG. 12 illustrates an exemplary screen of a monitored printing apparatus registration screen of the network apparatus according to the second exemplary embodiment of the present invention.

When the CPU 301 of the MFP 1 (1101) detects that the setting key 405 of the operation unit 40 is pressed, the CPU 301 of the MFP 1 (1101) displays the monitored printing apparatus registration screen illustrated in FIG. 12 on the touch panel 401 of the operation unit 40, so that the number of available hosts and the IP addresses of the printing apparatuses monitored as slaves can be registered.

In FIG. 12, an exemplary screen of a monitored printing apparatus registration 1200 includes information set in the MFP 1 (1101) (the IP addresses and the threshold value of the number of available hosts) and information set in the monitored printing apparatuses (below-described registered slave list).

When a user wants to add a monitored printing apparatus, the user gives instruction by touching an add button 1201. When the user wants to delete a monitored printing apparatus, the user gives instruction by touching a delete button 1202. When the user wants to edit information about a monitored printing apparatus, the user gives instruction by touching an edit button 1203.

The list about the monitored printing apparatuses registered from the monitored printing apparatus registration screen (FIG. 12) is stored as a registered slave list in a storage area in the NVRAM 304 of the MFP 1 (1101) for the threshold value of the number of available hosts of monitored apparatuses.

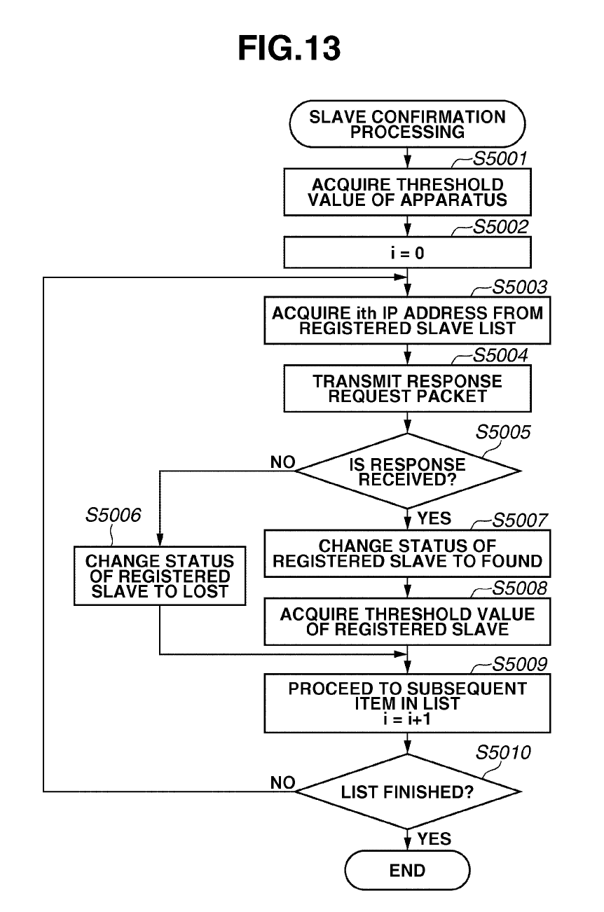

FIG. 13 illustrates an example of a slave confirmation processing performed by the network apparatus according to the present exemplary embodiment. The slave confirmation processing is executed when the registration screen illustrated in FIG. 12 is displayed. The processing in FIG. 13 is achieved by the CPU 301 of the MFP 1 (101) by reading and executing a program stored in the ROM 302.

When the registration screen illustrated in FIG. 12 is displayed, the CPU 301 of the MFP 1 (1101) starts the processing of FIG. 13.

In step S5001, the CPU 301 of the MFP 1 (1101) acquires the threshold value set in the MFP 1 (1101). Subsequently, in step S5002, the CPU 301 of the MFP 1 (1101) initializes the variable i stored in the RAM 303 to “0”.

Subsequently, in step S5003, the CPU 301 of the MFP 1 (1101) acquires the IP address of the printing apparatus registered as the ith item in the registered slave list. In step S5004, the CPU 301 of the MFP 1 (1101) transmits a response request packet to the IP address acquired in step S5003.

Subsequently, in step S5005, the CPU 301 of the MFP 1 (1101) determines a status based on whether the MFP 1 (1101) has received a response in reply to the response request packet transmitted in step S5004. When the CPU 301 of the MFP 1 (1101) determines that the MFP 1 (1101) has received a response (YES in step S5005), the processing proceeds to step S5007.

In step S5007, the CPU 301 of the MFP 1 (1101) updates the registered slave list so that the status of the printing apparatus registered as the ith item in the registered slave list (printing apparatus that sent the response) is changed to “FIND” (operating).

Then, in step S5008, the CPU 301 of the MFP 1 (1101) updates the registered slave list upon obtaining the threshold value of the number of available hosts of the printing apparatus registered as the ith item in the registered slave list (printing apparatus that sent the response), and the processing proceeds to step S5009.

On the other hand, in step S5005, when the CPU 301 of the MFP 1 (1101) determines that the MFP 1 (1101) has not yet received any response from the ith apparatus (NO in step S5005), the processing proceeds to step S5006.

In step S5006, the CPU 301 of the MFP 1 (1101) updates the registered slave list so that the status of the printing apparatus registered as the ith item in the registered slave list (printing apparatus that failed to send the response) is changed to “LOST” (not operating), and the processing proceeds to step S5009.

In step S5009, the CPU 301 of the MFP 1 (1101) increments the variable i, and the processing proceeds to step S5010. In step S5010, the CPU 301 of the MFP 1 (1101) determines whether the processing in steps S5003 to S5009 has been performed on all of the items in the registered slave list.

When the CPU 301 of the MFP 1 (1101) determines that the processing has not yet been performed on all of the items in the registered slave list (NO in step S5010), the processing returns back to step S5003.

In step S5010, when the CPU 301 of the MFP 1 (1101) determines that the processing in steps S5003 to S5009 has been performed on all of the items in the registered slave list (YES in step S5010), the CPU 301 of the MFP 1 (101) terminates the processing of this flowchart. Then, the CPU 301 of the MFP 1 (101) displays the monitored printing apparatus registration screen 1200 in FIG. 12 on the touch panel 401 of the operation unit 40 based on the registered slave list and the information about the MFP 1 (101) acquired in step S5001 (the IP address, the threshold value of the number of available hosts).

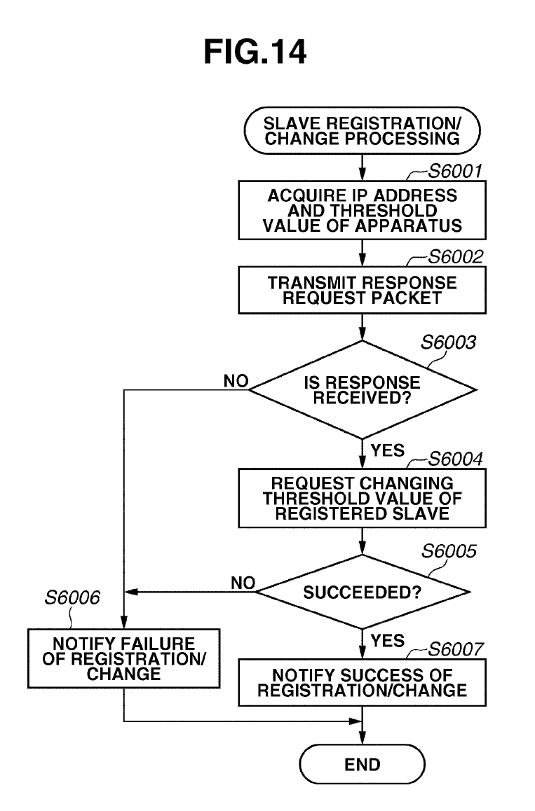

Adding or editing processing of the registered slave list performed on the printing apparatus registration screen will be described below with reference to FIG. 14.

FIG. 14 illustrates an example of the adding or editing processing of the registered slave list in the network apparatus according to the present exemplary embodiment. The processing in FIG. 14 is achieved by the CPU 301 of the MFP 1 (101) by reading and executing a program stored in the ROM 302.

When the add button 1201 or the edit button 1203 is pressed on the printing apparatus registration screen illustrated in FIG. 12, the CPU 301 of the MFP 1 (1101) starts the processing of FIG. 14.

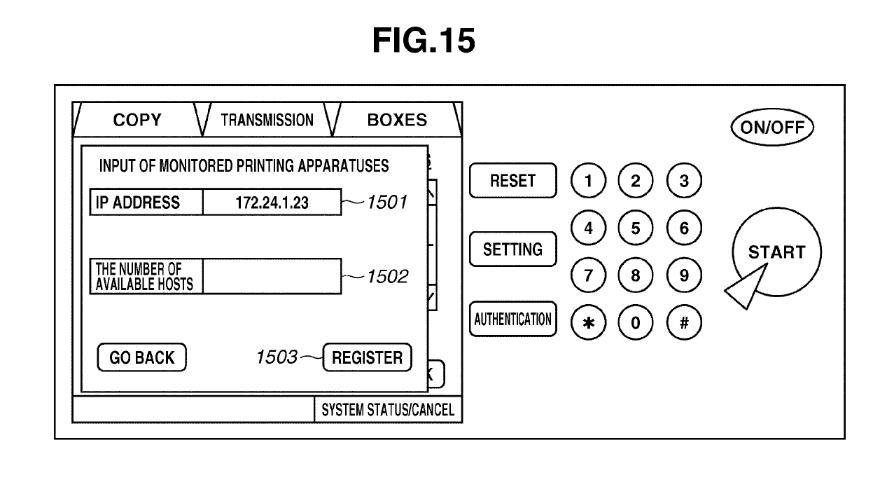

First, in step S6001, the CPU 301 of the MFP 1 (1101) displays a monitored printing apparatus input screen illustrated in FIG. 15 on the operation unit 40, and waits for a user to input an IP address and a threshold value of an apparatus to be added or edited.

FIG. 15 illustrates an example of the monitored printing apparatus input screen displayed on the network apparatus according to the second exemplary embodiment of the present invention. As illustrated in FIG. 15, a user inputs an IP address and a threshold value to an IP address input field 1501 and an available host number input field 1502 on the monitored printing apparatus input screen, and presses a registration button 1503. Then, the CPU 301 of the MFP 1 (1101) detects the pressing, acquires the IP address and the threshold value from the user input screen, and the processing proceeds to step S6002.

In step S6002, the CPU 301 of the MFP 1 (1101) transmits a response request packet to the IP address acquired in step S6001. Subsequently, the CPU 301 of the MFP 1 (1101) determines whether the MFP 1 (1101) has received a response in reply to the packet transmitted in step S6002. When the CPU 301 of the MFP 1 (1101) determines that the MFP 1 (1101) has received a response, the processing proceeds to step S6004.

In step S6004, the CPU 301 of the MFP 1 (1101) requests the printing apparatus (registered slave) with the IP address acquired in step S6001 to change the threshold value of the number of available hosts set in the registered slave to the threshold value acquired in S6001.

Subsequently, in step S6005, the CPU 301 of the MFP 1 (1101) determines whether the threshold value change request in step S6004 has been successfully finished. The determination is made based on whether the MFP 1 (1101) has received a response, in reply to the threshold value change request in step S6004, indicating a successful finish of the threshold value change request.

In step S6005, when the CPU 301 of the MFP 1 (1101) determines that the threshold value change request of step S6004 has been successfully finished (YES in step S6005), the processing proceeds to step S6007. In step S6007, the CPU 301 of the MFP 1 (1101) notifies a user that the slave registration/change processing has been successfully finished (displays on the touch panel 401 of the operation unit 40), and terminates the processing of FIG. 14.

On the other hand, in step S6005, when the CPU 301 of the MFP 1 (1101) determines that the threshold change request in step S6004 has failed (NO in step S6005), the processing proceeds to step S6006.

In step S6006, the CPU 301 of the MFP 1 (1101) notifies a user that the slave registration/change processing has failed (displays on the touch panel 401 of the operation unit 40), and terminates the processing of FIG. 14.

With the above processing, the number of operating printing apparatuses can be reduced according to the decrease of the number of users (according to the decrease of operating PCs) even in an environment such as in a large corporation (office), in which there are many shared printing apparatuses and many PCs connected to a network. Thus, electric power consumed in a user environment can be reduced without sacrificing user's convenience.

In the present exemplary embodiment, each of the network apparatuses (MFP) may have a different threshold value of the number of available hosts (Th) corresponding to each of the periods as illustrated in FIG. 8. In this case, needless to say, the master can also change the threshold values of the number of available hosts in each of the periods stored in the MFPs.

In the above description about the exemplary embodiments, the network apparatus is configured to turn off the main power source of the apparatus (step S2018 in FIG. 7) when the number of connected turned-on hosts (the number of available hosts) is less than the threshold value of the number of available hosts (Th). Alternatively, the network apparatus may be configured to go into a power-saving state such as power-saving mode when the number of available hosts is less than the threshold value of the number of available hosts (Th). In this configuration, the booting processing of FIG. 10 is also performed when the network apparatus recovers from the power-saving mode.

Further, a first threshold value of the number of available hosts (hereinafter referred to as first threshold value (Th1)) and a second threshold value of the number of available hosts (hereinafter referred to as second threshold value (Th2)) may be stored on the NVRAM 304 in advance. In this case, the first threshold value (Th1 ) is larger than the second threshold value (Th2 ).

The network apparatus may be configured so that the apparatus goes into the power-saving mode when the number of available hosts is less than the first threshold value (Th1 ) and the apparatus turns off the main power source of the apparatus when the number of available hosts is less than the second threshold value (Th2 ). Also in this configuration, the first threshold value (Th1 ) and the second threshold value (Th2 ) may be changed according to the periods of time as illustrated in FIG. 8.

Alternatively, when the number of available hosts is less than the threshold value of the number of available hosts (Th), the network apparatus may go once into the power-saving mode, and when there has been no access for a certain period of time thereafter, the network apparatus may turn off the main power source of the apparatus. Further, a combination of the above configurations may be employed.

With the above configurations, the power source of the network apparatus can be controlled in detail, and reliable power-consumption can be achieved without sacrificing user's convenience. In the description about each of the above exemplary embodiments and modifications thereof, the network apparatus according to the present invention is a printing apparatus such as an MFP for example. However, the present invention may be applied to any network apparatus as long as it can be connected to a network such as a LAN. For example, the present invention may be applied to an information processing apparatus such as a personal computer and a server computer.

It is to be understood that the above-described configurations and contents of various data are not limited to what is described above and can be made of various configurations and contents according to the usage and purpose.

The exemplary embodiments have been hereinabove described, however, the present invention may be embodied as various forms such as a system, an apparatus, a method, a program, or a recording medium. More specifically, the present invention may be applied to a system constituted by a plurality of devices or to an apparatus constituted by a single device.

As hereinabove described, even when some of the users are still operating their PCs, the power source of the network apparatus can be turned off, so that wasteful power consumption can be reduced.

Further, a main power source control start time (Tstart) and the main power source control end time (Tend) may be set in advance, so that the main power source off control processing (step S2018 in FIG. 7) can be performed only in a certain period of time. This enables a more reliable execution of the main power source off control processing (step S2018 in FIG. 7) during a period of time in which absence of users is highly possible.

The booting monitoring processing illustrated in FIG. 10 enables appropriate changing of the conditions of the main power source off control processing (step S2018 in FIG. 7) and preventing the main power source of the network apparatus from being turned off frequently by mistake. Therefore, it is possible to minimize the burden placed on a user to perform a power-on operation.

The arrangement of the network apparatus serving as a master enables reducing of the burden placed on the user who owns a plurality of apparatuses when the user configures and manages the threshold values.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-044630 filed Feb. 26, 2009, which is hereby incorporated by reference herein in its entirety.

What is claimed is:

1. A network apparatus capable of communicating with a plurality of terminal apparatuses via a network, the network apparatus comprising:
a receiving unit configured to receive packets from the plurality of terminal apparatuses;
a counting unit configured to count, based on the packets received by the receiving unit in a certain period of time, a number of terminal apparatuses from among the plurality of terminal apparatuses that can communicate with the network apparatus;
a control unit configured to shift the network apparatus into a power-saving state, when the number of terminal apparatuses counted by the counting unit is less than a predetermined threshold value; and
a threshold setting unit configured to set the predetermined threshold value.

2. The network apparatus according to claim 1, wherein the counting unit counts the number of terminal apparatuses based on a state of reception of a predetermined packet included in the packets received in the certain period of time.

3. The network apparatus according to claim 1 further comprising a period setting unit configured to set a period,
wherein in the period set by the period setting unit, the control unit controls the network apparatus to shift into the power-saving state, when the number of terminal apparatuses counted by the counting unit is less than a predetermined threshold value.

4. The network apparatus according to claim 3 further comprising:
an end time storage unit configured to store an end time representing an end of the period set by the period setting unit; and
a calculation unit configured to calculate a time difference between current time and the end time when the network apparatus is booted,
wherein the threshold value setting unit sets the predetermined threshold value, based on the time difference calculated by the calculation unit.

5. The network apparatus according to claim 1, wherein the predetermined threshold value is associated with any one of a plurality of periods of time, and
wherein when the number of terminal apparatuses counted by the counting unit is less than the predetermined threshold value set for a period of time corresponding to the current time, the control unit controls the network apparatus to shift into the power-saving state.

6. The network apparatus according to claim 1, wherein the predetermined threshold value includes a first threshold value and a second threshold value,
wherein when the number of terminal apparatuses counted by the counting unit is less than the first threshold value, the control unit controls the network apparatus to shift into the power-saving state, and
wherein when the number of terminal apparatuses counted by the counting unit is less than the second threshold value, the control unit shuts off a power source of the network apparatus.

7. The network apparatus according to claim 1 further comprising an instruction unit configured to issue a change request to another network apparatus capable of communicating via a network for instructing the network apparatus to change the predetermined threshold value of the network apparatus.

8. A method for controlling a network apparatus capable of communicating with a plurality of terminal apparatuses via a network, the method comprising:
receiving packets from the plurality of terminal apparatuses; and
counting, based on packets received in a certain period of time, the number of terminal apparatuses from among the plurality of terminal apparatuses that can communicate with the network apparatus;
controlling the network apparatus to shift into a power-saving state, when the number of counted terminal apparatuses is less than a predetermined threshold value.

9. The method according to claim 8, wherein counting the number of terminal apparatuses based on a state of reception of a predetermined packet included in the packets received in the certain period of time.

10. The method according to claim 8 further comprising:
setting a period,
wherein the network apparatus is controlled to shift into the power-saving state, when the counted number of terminal apparatuses is less than the predetermined threshold value in the set period.

11. The method according to claim 10 further comprising:
storing an end time indicating an end of the set period; and
calculating a time difference between current time and end time when the network apparatus is booted,
wherein the predetermined threshold value is set based on the time difference calculated in the calculation step.

12. The method according to claim 8, wherein the predetermined threshold value is associated with any one of a plurality of periods of time, and
wherein when the number of counted terminal apparatuses is less than the predetermined threshold value set for a period of time corresponding to the current time, the network apparatus is controlled to shift into the power-saving state in the control step.

13. The method according to claim 8, wherein the predetermined threshold value includes a first threshold value and a second threshold value,
wherein when the number of counted terminal apparatuses is less than the first threshold value, the network apparatus is controlled to shift into the power-saving state, and
wherein when the number of counted terminal apparatuses is less than the second threshold value, a power source of the network apparatus is shut off.

14. The method according to claim 8 further comprising:
issuing a change request to another network apparatus capable of communicating via a network for instructing the other network apparatus to change the predetermined threshold value of the other network apparatus.
